(19) United States
(12) Patent Application Publication
(10) Pub. No.: US 2024/0330397 A1
(43) Pub. Date: Oct. 3, 2024

(54) INFORMATION PROCESSING DEVICE, INFORMATION PROCESSING METHOD, AND STORAGE MEDIUM

(71) Applicant: HONDA MOTOR CO., LTD., Tokyo (JP)

(72) Inventor: Sho Nakajima, Wako-shi (JP)

(21) Appl. No.: 18/585,100

(22) Filed: Feb. 23, 2024

(30) Foreign Application Priority Data
Mar. 31, 2023 (CN) 202310342678.7

(51) Int. Cl. G06F 17/11

(52) U.S. Cl. CPC G06F 17/11

(57) ABSTRACT

An information processing device sets a sum value of thicknesses of a first member group and a second member group included in an electrode of a cylindrical battery, and an electrode length as the explanatory variable group, generates a cylindrical diameter of a wound body as an individual from the sum value of the thicknesses of the first member group and the second member group and the electrode length, and resets a reset value based on a plurality of explanatory variables with respect to the plurality of explanatory variables deviating from a pullback constraint for each individual.

### CROSS-REFERENCE TO RELATED APPLICATION

Priority is claimed on Chinese Patent Application No. 202310342678.7, filed Mar. 31, 2023, the content of which is incorporated herein by reference.

### BACKGROUND OF THE INVENTION

### Field of the Invention

The present invention relates to an information processing device, an information processing method, and a storage medium.

### Description of Related Art

Product design can be regarded as a multi-objective optimization problem that pursues a plurality of objectives. For example, in the design of batteries, the increase of a capacity, the increase of an output, the reduction of production costs, and the like are pursued. In multi-objective optimization problems, evolutionary algorithms may be used. Among the evolutionary algorithms, for example, a non-dominated sorting genetic algorithm (NSGA)-II may be used.

For example, in the following Patent Document 1, a system and method for obtaining a Pareto optimal solution in engineering design optimization of a product are disclosed. In the system and method, each independently conducted optimization's Pareto optimal solutions are combined to create a set of better converged and diversified solutions. Combinations can be performed at one or more predefined checkpoints during an evolutionary process of the optimization.

When an evolutionary algorithm is applied to product design, constraint conditions are imposed on explanatory variables indicating individual production requirements so that feasible production requirements can be obtained. In general, in the design of mass-produced products, in order to ensure feasibility, constraint conditions are imposed on a plurality of explanatory variables and a pullback process for the set value of the explanatory variable is performed to satisfy each constraint condition.
[Patent Document 1] Japanese Unexamined Patent Application, First Publication No. 2011-187056

### SUMMARY OF THE INVENTION

For example, when an evolutionary algorithm is applied to a cylindrical battery, even if each design for the electrode is an optimal design based on realistic constraints, a winding diameter may deviate from the diameter of a cylindrical can in the process of winding the electrode in a subsequent step and inserting it into the cylindrical can. On the other hand, even if there are trials to solve this battery cell-specific problem, because there are many components affecting dimensions and variable values capable of being changed and fixed values determined on the basis of the step and the design concept are complexly present at the same time, this problem cannot be solved in simple methods such as constraints on each independent explanatory variable of the conventional method or pulling back all variables by calculating proportions.

An aspect according to the present invention has been made in view of the above problems and an objective of the present invention is to provide an information processing device, an information processing method, and a storage medium capable of designing an electrode that can be encapsulated in a cylindrical container while maintaining the balance of an evolutionary result of multi-objective optimization.

To solve the above-described problems and achieve the objective, the present invention adopts the following aspects.

(1): According to an aspect of the present invention, there is provided an information processing method in which an information processing device executes a crossover step of generating a new individual by changing a value of an explanatory variable of a part of an individual selected with a first probability from current-generation data, which has n (n is an integer of 3 or more) individuals each being an explanatory variable group having a plurality of explanatory variables, to a target value based on a value of a corresponding explanatory variable of another individual, a mutation step of generating a new individual by changing a value of an explanatory variable of a part of an individual selected with a second probability from the current-generation data to another value, and a sorting step of sorting n individuals of next-generation data from stored individuals and generated individuals on the basis of a fitness degree calculated from an explanatory variable group for each individual, wherein the information processing device executes: a setting step of setting information indicating a sum value of thicknesses of a first member group included in an electrode of a cylindrical battery, information indicating a sum value of thicknesses of a second member group, and information indicating an electrode length as the explanatory variable group; a generation step of generating a diameter of a wound body as an individual from the information indicating the sum value of the thicknesses of the first member group, the information indicating the sum value of the thicknesses of the second member group, and information indicating the electrode length set in the setting step; a pullback constraint determination step of determining presence or absence of an explanatory condition deviating from the pullback constraint, which is a constraint condition across a plurality of explanatory variables for each individual generated in the generation step; and a pullback step of resetting a reset value based on a plurality of explanatory variables with respect to the plurality of explanatory variables deviating from the pullback constraint.

(2): In the above-described aspect (1), the pullback constraint may indicate that the diameter of the wound body is less than or equal to a diameter of a cylindrical container, and the pullback step may include determining the reset value so that the diameter of the wound body is less than or equal to the diameter of the cylindrical container on the basis of the plurality of explanatory variables with respect to the plurality of explanatory variables deviating from the pullback constraint.

(3): In the above-described aspect (1), the setting step may include setting information indicating a cylindrical diameter, information indicating a winding core diameter, and information indicating a sum value of thicknesses of a third member group included in the electrode of the cylindrical battery, and the generation step may include generating the diameter of the wound body from the sum value of the thicknesses of the first member group, the sum value of the thicknesses of the second member group, the electrode length, the cylindrical diameter, the winding core diameter, and the sum value of the thicknesses of the third member group included in the electrode of the cylindrical battery.

(4): In the above-described aspect (3), the first member group may include a positive electrode collector foil and a negative electrode collector foil, the second member group may include a positive electrode active material and a negative electrode active material, and the third member group may include a separator.

(5): According to an aspect of the present invention, there is provided a computer-readable non-transitory storage medium storing a computer program for causing a computer of an information processing device to execute the information processing method according to the above-described aspect (1).

(6): According to an aspect of the present invention, there is provided an information processing device including a storage unit configured to store current-generation data, which has n (n is an integer of 3 or more) individuals each being an explanatory variable group having a plurality of explanatory variables; and an individual processing unit configured to generate a new individual by changing a value of an explanatory variable of a part of an individual selected with a first probability from the current-generation data to a target value based on a value of a corresponding explanatory variable of another individual, generate a new individual by changing a value of an explanatory variable of a part of an individual selected with a second probability from the current-generation data to another value, and sort n individuals of next-generation data from stored individuals and generated individuals on the basis of a fitness degree calculated from an explanatory variable group for each individual, wherein the individual processing unit sets information indicating a sum value of thicknesses of a first member group included in an electrode of a cylindrical battery, information indicating a sum value of thicknesses of a second member group, and information indicating an electrode length as the explanatory variable group, generates a diameter of a wound body as an individual from the information indicating the sum value of the thicknesses of the first member group, the information indicating the sum value of the thicknesses of the second member group, and the information indicating the electrode length that have been set, determines presence or absence of an explanatory condition deviating from the pullback constraint, which is a constraint condition across a plurality of explanatory variables for each individual that has been generated, and resets a reset value based on a plurality of explanatory variables with respect to the plurality of explanatory variables deviating from the pullback constraint.

According to the above-described aspects (1) to (6), it is possible to design an electrode that can be encapsulated in a cylindrical container while maintaining the balance of an evolutionary result of multi-objective optimization.

### BRIEF DESCRIPTION OF THE DRAWINGS

FIG. 1 is a schematic block diagram showing an example of a functional configuration of an information processing device according to the present embodiment.

FIG. 2 is a schematic block diagram showing an example of a hardware configuration of the information processing device according to the present embodiment.

FIG. 3 is a bird's-eye view showing information processing according to the present embodiment.

FIG. 4 is an explanatory diagram showing an example of a group of explanatory variables according to the present embodiment.

FIG. 5 is an explanatory diagram showing an example of individual constraint conditions according to the present embodiment.

FIG. 6 is an explanatory diagram showing an example of a crossover step according to the present embodiment.

FIG. 7 is an explanatory diagram showing an example of a mutation step according to the present embodiment.

FIG. 8A is a schematic diagram showing an example of a cylindrical battery according to the present embodiment.

FIG. 8B is a schematic diagram showing an example of a cylindrical battery according to the present embodiment.

FIG. 8C is a schematic diagram showing an example of a cylindrical battery according to the present embodiment.

FIG. 9 is a flowchart showing another example of information processing according to the present embodiment.

### DETAILED DESCRIPTION OF THE INVENTION

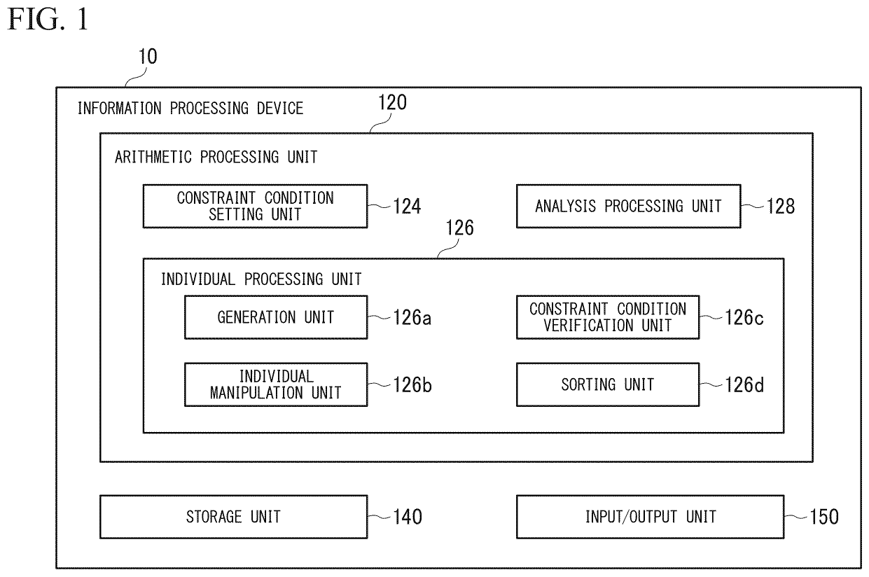

The present embodiment will be described with reference to the drawings. FIG. 1 is a schematic block diagram showing an example of a functional configuration of an information processing device 10 according to the present embodiment. The information processing device 10 according to the present embodiment acquires product data and stores the acquired product data. The product data has n individuals. n corresponds to the number of individuals and is a predetermined integer of 3 or more. Each individual constitutes an explanatory variable group having a plurality of explanatory variables indicating individual-product production conditions. The product production conditions include the material or design of the product. The explanatory variable group is used to predict the performance of the product produced in accordance with its production condition. The information processing device 10 calculates a fitness degree indicating the overall performance of the product on the basis of the objective variable. The objective variable is an index of an individual element of performance. The information processing device 10 calculates an objective variable using a learning model for an explanatory variable group.

The information processing device 10 executes a process for solving a multi-objective optimization problem using an evolutionary algorithm on product data. The information processing device 10 executes a crossover step of generating a new individual by changing a value of an explanatory variable of a part of an individual selected with a predetermined crossover probability from current-generation product data, which has n individuals, to a value determined on the basis of a value of a corresponding explanatory variable of another individual, a mutation step of generating a new individual by changing a value of an explanatory variable of a part of an individual selected with a second probability from current-generation data to another value, and a sorting step of sorting n individuals of next-generation data from stored individuals and generated individuals on the basis of a fitness degree calculated from an explanatory variable group for each individual. Therefore, some individuals are rejected on the basis of the fitness degree for each generation and replaced with new individuals.

In the present embodiment, the current-generation product data is referred to as “current-generation data” and next-generation product data following the current generation may be referred to as “next-generation data.” First-generation product data is sometimes referred to as “first-generation data” and last-generation product data is referred to as “last-generation data.”

In this regard, the information processing device 10 includes a pullback constraint determination step of determining presence or absence of an explanatory condition deviating from the pullback constraint, which is a constraint condition across a plurality of explanatory variables for each generated individual, a pullback step of resetting a reset value based on a plurality of explanatory variables with respect to the plurality of explanatory variables deviating from the pullback constraint, and an individual constraint determination step of determining whether or not each of reset values of the plurality of explanatory variables satisfies an individual constraint condition, which is a constraint condition related to each explanatory variable.

When there is a constraint deviation individual that is an individual having a reset value of an explanatory variable deviating from the individual constraint condition, the information processing device 10 executes the crossover step for the constraint deviation individual. Because it is not necessary to reject an individual that does not satisfy both the pullback constraint and the individual constraint condition, the decrease in prediction accuracy is suppressed and the increase in a calculation amount is suppressed. Furthermore, because there is no re-calculation and the balancing effect of a high fitness degree is also maintained, there is little time loss and the evolutionary direction can be continuously maintained.

Next, an example of a functional configuration of the information processing device 10 will be described. The information processing device 10 includes an arithmetic processing unit 120, a storage unit 140, and an input/output unit 150.

The arithmetic processing unit 120 includes a constraint condition setting unit 124, an individual processing unit 126, and an analysis processing unit 128.

The constraint condition setting unit 124 sets a constraint condition imposed on the explanatory variable group constituting each individual and stores constraint condition information indicating the set constraint condition in the storage unit 140.

Constraint conditions are classified into an individual constraint condition applied to each explanatory variable and a pullback condition applied to a plurality of explanatory variables. The individual constraint condition mainly defines a value range of explanatory variables. More specifically, the individual constraint condition may indicate whether a type of explanatory variable is a continuous value or a discrete value and one or both of maximum and minimum values of a possible value.

For the discrete value, an interval may be further indicated for the maximum value or the minimum value or a plurality of candidate values may be indicated instead of the maximum value or the minimum value.

The pullback condition defines, for example, a value range for a sum of a plurality of explanatory variables to be targeted, a function indicating a relationship between two or more explanatory variables, and the like.

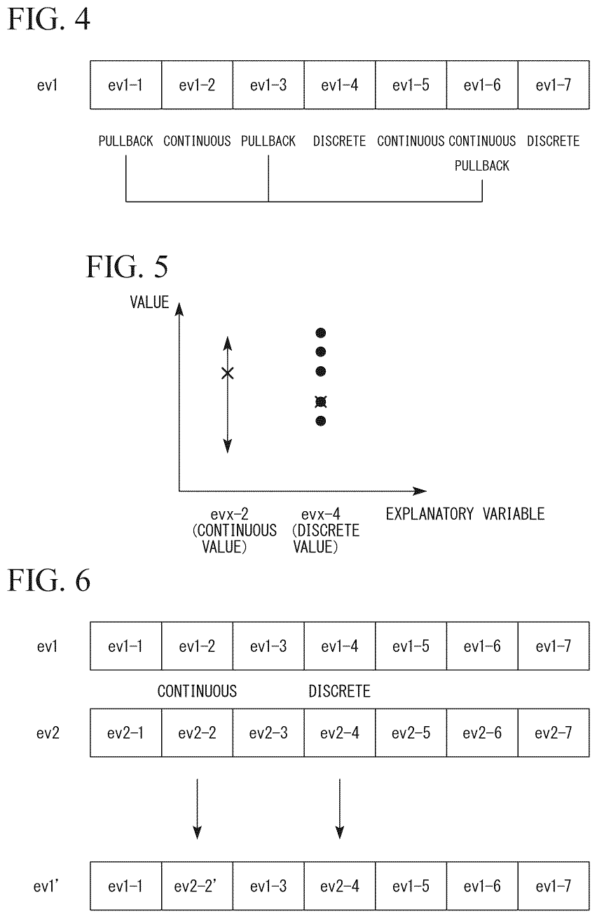

The individual constraint condition and the pullback condition are not necessarily applied exclusively, but may be applied in duplicate. That is, both the individual constraint condition and the pullback condition may be applied to a single type of explanatory variable. In the example of FIG. 4, in an individual ev1, an explanatory variable ev1-6 has any one real value among continuous values in the range between the minimum value and the maximum value set as an individual constraint condition and a pullback condition is set between explanatory variables ev1-1 and ev1-3. In FIG. 4, “pullback” indicates that a pullback condition is set. “Continuous” indicates a continuous value. “Discrete” indicates a discrete value.

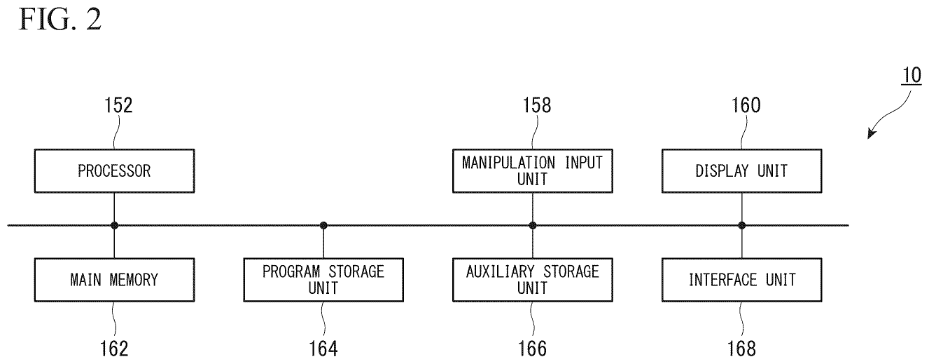

The constraint condition setting unit 124, for example, adds, changes, or deletes various types of constraint conditions in accordance with operation information input from the manipulation input unit 158 (FIG. 2). The constraint condition setting unit 124 may acquire constraint condition information indicating the constraint condition from other equipment. Specific examples of constraint conditions will be described below. The individual processing unit 126 includes a generation unit 126a, an individual manipulation unit 126b, a constraint condition verification unit 126c, and a sorting unit 126d.

The generation unit 126a sets an explanatory variable group, reads the constraint condition information stored in the storage unit 140, refers to the read constraint condition information, and identifies a constraint condition applied to each explanatory variable included in the set explanatory variable group.

The generation unit 126a generates n individuals as initial individuals so that they satisfy the identified constraint condition and configures first-generation product data including the generated initial individuals. The generation unit 126a stores the configured product data as first-generation data in the storage unit 140.

When an initial individual is generated, the generation unit 126a sets a value of the explanatory variable to satisfy an individual constraint condition imposed on each explanatory variable for each explanatory variable constituting each individual. For example, for an explanatory variable having a continuous value in which the maximum value and the minimum value are defined, the generation unit 126a randomly selects one real value within the range of the minimum value and the maximum value as the value of the explanatory variable (see FIG. 5). For an explanatory variable having a discrete value, the generation unit 126a randomly selects any one candidate from a plurality of possible value candidates as the value of the explanatory variable. In the present embodiment, “randomly” means “stochastically,” more specifically, using pseudo-random numbers.

When a pullback constraint across a plurality of explanatory variables is imposed, the constraint condition verification unit 126c executes a pullback constraint determination step for each individual. The pullback constraint determination step is a process of determining whether or not the values of a plurality of explanatory variables to be targeted satisfy the pullback constraint condition.

For a plurality of explanatory variables deviating from the pullback constraint, the constraint condition verification unit 126c executes a pullback step for the plurality of explanatory variables. The pullback process is a process of resetting values (reset values) based on a plurality of explanatory variables between two or more explanatory variables.

The constraint condition verification unit 126c executes an individual constraint determination step for the reset values of a plurality of explanatory variables that have been reset. The individual constraint determination step is a process for determining whether or not the individual constraint condition applied to each explanatory variable is satisfied. When there is an individual in which there is an explanatory variable whose reset value does not satisfy the individual constraint condition, a crossover step is executed.

The constraint condition verification unit 126c may execute the pullback determination step for a new individual and may interrupt the process when there are a plurality of explanatory variables deviating from the pullback constraint.

The individual manipulation unit 126b designates n individuals included in the current-generation data stored in the storage unit 140 as parent individuals, performs genetic manipulations on the parent individuals, and generates new individuals as child individuals. The individual manipulation unit 126b includes and stores the generated child individuals in the current-generation data. The genetic manipulation includes crossover and mutation steps.

The crossover step includes the following processing of S62 to S68.

(S62) An explanatory variable of interest that is an explanatory variable which is a part of an individual of interest to be processed is randomly selected from n parent individuals.

(S64) One parent individual among the remaining n−1 parent individuals is randomly selected as a reference individual serving as a reference destination.

(S66) On the basis of the value of the explanatory variable of interest in the reference individual, a first target value is determined for the individual of interest. On the basis of the value of the explanatory variable of interest in the individual of interest, a second target value is determined for the reference individual.

(S68) The value of the explanatory variable of interest in the individual of interest is replaced with the first target value, the values of the other explanatory variables are maintained, and a new individual is generated as a child individual. A new individual in which the value of the explanatory variable of interest in the reference individual is replaced with the second target value and values of the other explanatory variables are maintained is generated as a child individual.

The individual manipulation unit 126b iterates the processing of S62 to S68 until the number of child individuals reaches p (p is a predetermined integer greater than 1 and less than n). p/2n corresponds to a crossover ratio. In the individual manipulation unit 126b, the number p is set in advance on the basis of the crossover ratio.

In the processing of S66, a method of determining the target value to be set for the explanatory variable of interest differs according to whether the explanatory variable of interest is a continuous value or a discrete value. For example, when the explanatory variable of interest is a discrete value, the individual manipulation unit 126b defines the value of the explanatory variable of interest in the reference individual and the value of the explanatory variable of interest in the individual of interest as the first target value and the second target value, respectively (uniform crossover). When the explanatory variable of interest has a continuous value, the individual manipulation unit 126b can determine the first target value and the second target value using a simulated binary crossover (SBX) method. The SBX method has a center of gravity on the value of the explanatory variable of interest in the reference individual and the value of the explanatory variable of interest in the individual of interest and has a step of setting a predetermined first probability distribution and a second probability distribution symmetrical to each other in a parameter space of the explanatory variable of interest and a step of determining a first target value randomly according to the first probability distribution and determining a second target value randomly according to the second probability distribution.

FIG. 6 shows an example of a case where a child individual ev1′ is generated according to a crossover of an individual ev1 of interest and a reference individual ev2. For the explanatory variable ev1-2 of interest, which is a continuous value, the original value ev1-2 is replaced with the second target value ev2-2′ using a probability density function around the explanatory variable ev2-2 of interest in the reference individual ev2 on the basis of the SBX method. For the explanatory variable ev1-4 of interest, which is a discrete value, the corresponding explanatory variable ev2-4 of interest in the reference individual ev2 is replaced with the second target value ev2-4 and the original value ev1-4 is replaced. An explanatory variable group including a value of an explanatory variable of interest obtained in replacement and a value of another explanatory variable in the individual of interest is generated as a child individual ev1′.

The mutation step includes the following processing of S82 and S84.

(S82) An explanatory variable of interest, which is an explanatory variable of a part of the individual of interest to be processed from n parent individuals, is randomly selected at a predetermined mutation ratio.

(S84) A new individual in which a target value of an explanatory variable of interest is randomly determined, an original value of the explanatory variable of interest is replaced with a target value, and values of other explanatory variables are maintained is generated as a child individual.

In this regard, when the explanatory variable of interest is a continuous value and the maximum value and the minimum value are set as individual constraint conditions, a real value of one of the continuous values within the range between the minimum value and the maximum value is determined to be a target value. When the explanatory variable of interest is a discrete value, one candidate value randomly selected from a plurality of candidate values set as individual constraint conditions is determined to be a target value.

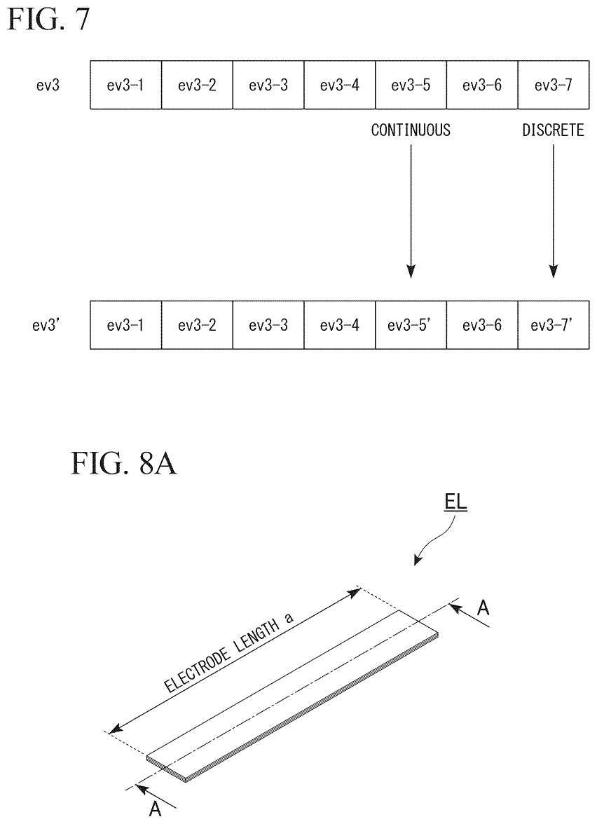

FIG. 7 shows an example of a case where a child individual ev3′ is generated according to the mutation of an individual ev3 of interest. For the explanatory variable ev3-5 of interest, which is a continuous value, a real value ev3-5′ is randomly determined to be a target value within a range between the minimum value and the maximum value set as an individual constraint condition. For the explanatory variable ev3-7 of interest, which is a discrete value, any one candidate ev3-7′ is randomly determined to be a target value from a plurality of value candidates set as an individual constraint condition. An explanatory variable group including a value of an explanatory variable of interest obtained in replacement and a value of another explanatory variable is generated as the child individual ev3′.

When a pullback constraint is imposed across a plurality of explanatory variables, the constraint condition verification unit 126c executes the above-described pullback constraint determination step for each of the generated child individuals.

For a plurality of explanatory variables deviating without satisfying the pullback constraints, the constraint condition verification unit 126c executes a pullback step for the plurality of explanatory variables.

The constraint condition verification unit 126c executes an individual constraint determination step for reset values of a plurality of explanatory variables that have been reset. The individual manipulation unit 126b designates a child individual in which there are explanatory variables whose reset values do not satisfy the individual constraint condition as a parent individual and performs a genetic manipulation thereon to generate a new individual as the child individual.

The sorting unit 126d calculates a fitness degree using a predetermined mathematical model for each individual constituting the current-generation data. As the fitness degree, an index of performance of a product is applied. The sorting unit 126d selects n individuals in descending order of fitness degrees from n parent individuals and newly generated child individuals. Here, an individual to which a fitness degree indicating good performance is assigned is preferentially selected. The sorting unit 126d stores next-generation data including the n individuals, which have been selected, in the storage unit 140.

The performance of a product is generally evaluated using a plurality of elements. For example, when the product is a battery, an index quantitatively indicating the capacity, output, cost, or the like thereof can be an element. The capacity corresponds to an amount of charge obtained in a discharging process until a termination voltage is reached from the start of the discharging process when an output voltage between two electrodes is a rated voltage. The output corresponds to an electric current or power obtained in the discharging process when the output voltage is equal to the rated voltage. The cost is the cost of manufacturing the product. The cost may include various expenses required for processing, distribution, and the like as well as the unit price of each member.

An individual element may be applied as a fitness degree or an index obtained by integrating a plurality of elements may be applied. It is only necessary for a function of calculating a fitness degree by integrating element indices related to a plurality of elements to be a function that monotonically changes to a numerical value indicating better performance when a change to a numerical value indicating good performance is made for each element. For example, the sorting unit 126d can calculate an element index ak using a learning model learned for each element type k from an explanatory variable group of each individual and can calculate a weighted sum between element types k of the calculated element index ak as a fitness degree. In the model learning, a parameter set of the learning model is predetermined so that a predicted value of the objective variable calculated using the learning model from a known explanatory variable group for each element type k and a target value of the objective variable corresponding to the explanatory variable group are approximated as the entire training data.

As the learning model, for example, one of a linear model learned using a multiple regression analysis, ridge regression, least absolute shrinkage and selection operator (LASSO) regression, elastic net, or the like and a nonlinear model such as a support vector machine, a neural network, AdaBoost, or random forest may be used. A different learning model may be used for each element type k. In the sorting unit 126d, a weight coefficient wk used for calculating a fitness degree is set in advance.

The analysis processing unit 128 selects one or more individuals on the basis of a fitness degree calculated from the explanatory variable group among individuals constituting the product data stored in the storage unit 140. For example, the analysis processing unit 128 configures a display screen by associating the fitness degree with the explanatory variable group of the selected individual and outputs display data indicating the configured display screen to the display unit 160 (FIG. 2). The analysis processing unit 128 may include an element index calculated from the explanatory variable group in the display screen in association with the explanatory variable group or the fitness degree.

The analysis processing unit 128 may evaluate the growth potential of n parent individuals as a whole for each generation. Statistics that are indices of growth potential (hereinafter sometimes referred to as “growth potential index values”) can include an optimal value of a fitness degree between individuals (hereinafter sometimes referred to as an “optimal fitness degree”) and a discreteness degree.

The discreteness degree is a degree to which the explanatory variables are randomly distributed across the entire vector space without being concentrated around a particular value. As an index indicating a discrete value, for example, any of the variance between individuals, an average distance between individuals, and the like may be used. In general, as a set of individuals grows normally, the growth potential index value tends to increase, and a growth rate, i.e., an amount of change thereof, tends to decrease. The analysis processing unit 128 may output display data indicating a display screen including a growth potential index value to the display unit 160.

The storage unit 140 stores various types of data temporarily or permanently.

The input/output unit 150 can input or output various types of input data with other equipment.

Instead of outputting various types of display data to the display unit 160, the analysis processing unit 128 may output various types of display data to other equipment via the input/output unit 150.

Instead of inputting various types of manipulation information from the manipulation input unit 158, the constraint condition setting unit 124 and the individual processing unit 126 may input various types of manipulation information from other equipment via the input/output unit 150. The other equipment may be connected via a communication network.

Next, an example of a hardware configuration of the information processing device 10 according to the present embodiment will be described. FIG. 2 is a schematic block diagram showing the example of the hardware configuration of the information processing device 10 according to the present embodiment. The information processing device 10 is configured to include a processor 152, a manipulation input unit 158, a display unit 160, a main memory 162, a program storage unit 164, an auxiliary storage unit 166, and an interface unit 168. The processor 152, the manipulation input unit 158, the display unit 160, the main memory 162, the program storage unit 164, the auxiliary storage unit 166, and the interface unit 168 are connected by a bus, and can input/output various types of data from/to each other.

The processor 152 executes arithmetic processes indicated in the instructions described in various types of programs. The processor 152 controls an operation of the entire information processing device 10. The processor 152 is, for example, a central processing unit (CPU). In the present application, executing the arithmetic process indicated in the instruction described in the program may be referred to as “executing the program”, “execution of the program”, or the like.

The manipulation input unit 158 can receive a manipulation and generates a manipulation signal in accordance with the received manipulation. Various types of manipulation information are indicated in manipulation signals. The manipulation input unit 158 may include general-purpose members such as a mouse, a touch sensor, and a keyboard, or may have dedicated members such as buttons and dials.

The display unit 160 displays a display screen in accordance with the display data input to its own unit. The display unit 160 may be one of a liquid crystal display, an organic electroluminescent display, and the like.

The main memory 162 is a writable memory used as a reading area for an executable program of the processor 152 or as a work area for writing processing data of the executable program. The main memory 162 is configured to include, for example, a random-access memory (RAM).

The program storage unit 164 stores system firmware such as a basic input output system (BIOS), firmware of various types of devices, other programs, and setting information required for executing the programs. The program storage unit 164 includes, for example, a read only memory (ROM).

The auxiliary storage unit 166 permanently stores various types of data and programs that are rewritable. The auxiliary storage unit 166 may be, for example, a hard disk drive (HDD), a solid-state storage device (solid-state drive (SSD)), or the like.

The interface unit 168 connects to other equipment by wire or wirelessly so that various types of data can be input/output. The interface unit 168 includes one or both of an input/output interface and a communication interface.

The processor 152 and the main memory 162 correspond to the minimum hardware used to implement the computer system of the information processing device 10. The processor 152 mainly implements a function of the arithmetic processing unit 120 by executing a predetermined program in cooperation with the main memory 162 and other hardware. The main memory 162, the program storage unit 164, and the auxiliary storage unit 166 implement the main functions of the storage unit 140. The interface unit 168 implements the main function of the input/output unit 150.

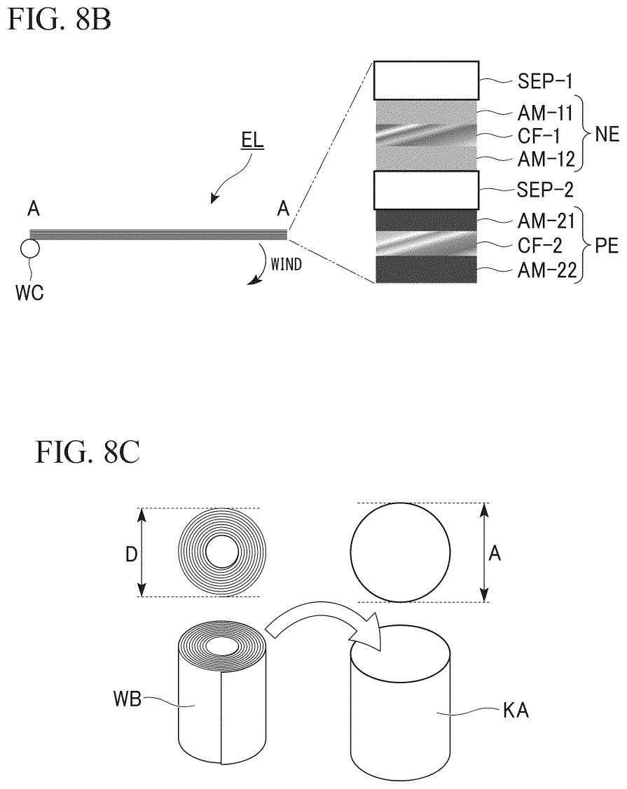

Next, an example of information processing according to the present embodiment will be described. As an example of information processing, a case where a cell of a cylindrical battery is designed will be described. The cylindrical battery includes a long thin sheet-shaped positive electrode, a separator, and a negative electrode stacked on top of each other, wound with a winder, and stored in a cylindrical container. FIGS. 8A to 8C are schematic diagrams showing an example of the cylindrical battery according to the present embodiment. FIG. 8A shows an electrode EL. An example of the shape of the electrode EL is a rectangle, and the longitudinal length of the electrode EL is indicated by an electrode length α

The left view of FIG. 8B is a cross-sectional view of the electrode EL shown in FIG. 8A viewed in a direction A-A (a direction perpendicular to a longitudinal direction) and the right view of FIG. 8B is an enlarged view of a cross-section. The electrode EL includes a separator SEP-1, a negative electrode NE, a separator SEP-2, and a positive electrode PE. The negative electrode NE includes an active material AM-11, a current collector foil CF-1, and an active material AM-12 and the positive electrode PE includes an active material AM-21, a current collector foil CF-2, and an active material AM-22.

The left view of FIG. 8C shows a wound body WB. The wound body WB is cylindrical in shape and is created by winding the electrode EL around a winding core WC. The right view of FIG. 8C shows a cylindrical container (can) KA. The wound body WB is stored by being inserted into the cylindrical container KA. In order for the wound body WB to be stored in the cylindrical container KA, a diameter D of the top and bottom surfaces of the wound body WB (hereinafter referred to as a “diameter D of the wound body WB”) needs to be a diameter A of the cylindrical container KA or less. Specifically, it is necessary for Inequality (1) to be valid.

$$\\ \begin{matrix}A \geq \sqrt{\frac{( ( {\sum }_{i}^{n} i ) + 2 ( {\sum }_{j}^{N} j ) + C ) \times a}{250 π} + ( {B}^{{}_{} 2} )} & ( 1 )\end{matrix}$$

In Inequality (1), “A” denotes a diameter [mm] of the cylindrical can, “B” denotes a diameter [mm] of the winding core WC, and “C” denotes a sum [μm] of thicknesses of a member (hereinafter referred to as “constant member”) assumed to be constant among the members constituting the electrode EL. When the constant member is assumed to be a separator, because the electrode EL includes two layers of separators (the separator SEP-1 and the separator SEP-2), “C” denotes a value obtained by multiplying the thickness of the separator of one layer by 2.

In Inequality (1), “i” denotes a sum [μm] of thicknesses of a member group (hereinafter referred to as a “first variable member group”) assumed to be a variable among the members constituting the electrode EL, “j” denotes a sum [μm] of thicknesses of a member group (hereinafter referred to as a “second variable member group”) having a greater influence than the first variable member group when assumed to be a variable among the members constituting the electrode EL, and “a” denotes an electrode length [mm]. When the first variable member group is assumed to be a current collector foil, because the electrode EL includes two layers of current collection foils (a current collector foil CF-1 and a current collection foil CF-2), “i” denotes a value obtained by multiplying the thickness of the current collection foil of the one layer by 2. When the second variable member group is assumed to be the active material, because the electrode EL includes four layers active materials (an active material AM-11, an active material AM-12, an active material AM-21, and an active material AM-22), “j” denotes a value obtained by multiplying the thickness of one layer of the active material by 4.

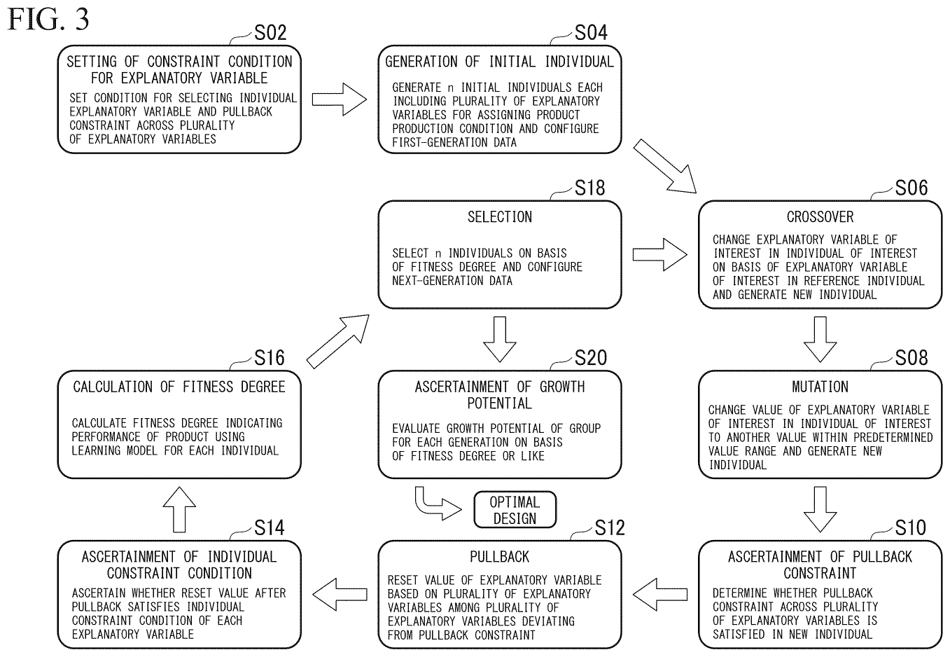

FIG. 3 is a bird's-eye view showing an example of information processing according to the present embodiment.

### (Step S02)

The constraint condition setting unit 124 sets an individual constraint condition to be applied to an individual explanatory variable as a constraint condition imposed on an explanatory variable group and a pullback constraint as a constraint condition to be applied across a plurality of explanatory variables. Specifically, the constraint condition setting unit 124 sets a constraint imposed on each of the sum i of the thicknesses of the first variable member group, the sum j of the thicknesses of the second variable member group, and the electrode length α as an individual constraint condition and sets a constraint condition imposed on the diameter D of the wound body WB or sets the diameter D of the wound body WB to be less than or equal to the diameter A of the cylindrical can KA as a pullback constraint.

### (Step S04)

The generation unit 126a generates n initial individuals each including a plurality of explanatory variables indicating a product production condition. Specifically, the generation unit 126a generates the diameter D of the wound body WB. The constraint condition verification unit 126c verifies that all generated initial individuals satisfy the set constraint condition. The generation unit 126a configures first-generation data including the n initial individuals satisfying the constraint condition as parent individuals and stores the first-generation data in the storage unit 140.

The individual processing unit 126 iterates the processing of steps S06 to S18 G times. G is an integer of 2 or more indicating the predetermined number of generations.

### (Step S06)

The individual manipulation unit 126b iteratively executes a crossover step in accordance with a predetermined crossover ratio. In the crossover step, the individual manipulation unit 126b randomly selects an explanatory variable of interest in an individual of interest from a parent individual. The individual manipulation unit 126b generates a new individual by changing a value of the explanatory variable of interest in the individual of interest to a target value based on the value of the explanatory variable of interest in the randomly selected reference individual. The individual manipulation unit 126b includes the new individual as a child individual in the current-generation data.

### (Step S08)

The individual manipulation unit 126b iteratively executes a mutation step according to a predetermined mutation ratio. In the mutation process, the individual manipulation unit 126b randomly selects the explanatory variable of interest in the individual of interest according to the mutation ratio from the parent individual. The individual manipulation unit 126b generates a new individual as a child individual by changing the value of the explanatory variable of interest in the individual of interest to a target value randomly selected within a value range constituting the individual constraint condition in the explanatory variable of interest. The individual manipulation unit 126b includes the new individual as a child individual in the current-generation data.

### (Step S10)

When a pullback constraint is imposed across a plurality of explanatory variables, the constraint condition verification unit 126c executes a pullback constraint determination step for each of the newly generated child individuals and determines whether or not the pullback constraint is satisfied for the plurality of explanatory variables.

### (Step S12)

The constraint condition verification unit 126c executes a pullback step for a plurality of explanatory variables that deviate from the pullback constraint and resets values based on the plurality of explanatory variables. Specifically, the constraint condition verification unit 126c resets the sum i of the thicknesses of the first variable member group, the sum j of the thicknesses of the second variable member group, and the electrode length α on the basis of Pullback Expressions (2).

$$\\ \begin{matrix}i ← i \times {C}_{r}^{{}_{} \frac{1}{2}} - \frac{C ( 1 - {C}_{r}^{{}_{} \frac{1}{2}} )}{n + N} , j ← j \times {C}_{r}^{{}_{} \frac{1}{2}} - \frac{C ( 1 - {C}_{r}^{{}_{} \frac{1}{2}} )}{2 ( n + N )} , a ← a \times {C}_{r}^{{}_{} \frac{1}{2}} & ( 2 )\end{matrix}$$

In Expressions (2), Cᵣ is Eq. (3).

$$\\ \begin{matrix}{C}_{r} = \frac{250 π ( {A}^{{}_{} 2} - {B}^{{}_{} 2} )}{( ( {\sum }_{i}^{n} i ) + 2 ( {\sum }_{j}^{N} j ) + C ) \times a} & ( 3 )\end{matrix}$$

### (Step S14)

The constraint condition verification unit 126c executes an individual constraint determination step with respect to the reset values of the plurality of explanatory variables that have been reset and determines whether or not the reset values satisfy the individual constraint condition. For an individual having an explanatory variable whose reset value deviates without satisfying the individual constraint condition, the process returns to step S06 and is executed from the crossover step.

### (Step S16)

The sorting unit 126d calculates a fitness degree indicating the performance of the product for each individual included in the current-generation data.

### (Step S18)

The sorting unit 126d selects n individuals in descending order of performance indicated by the fitness degree, configures next-generation data including the n selected individuals and stores the next-generation data in the storage unit 140. Thereafter, the process returns to step S06.

### (Step S20)

The analysis processing unit 128 evaluates a growth potential of a group on the basis of the fitness degree of each individual or the like for each generation. For example, the analysis processing unit 128 calculates an optimal fitness degree as a growth index value on the basis of fitness degrees of n individuals for each generation.

After the processing of steps S08 to S18 is iterated G times, the analysis processing unit 128 selects one or more predetermined individuals in descending order of fitness degrees and outputs optimal design information indicating the production condition shown in the explanatory variable group constituting the selected individual to the display unit 160 or other equipment.

Regardless of whether or not the number of generations G has been set, the analysis processing unit 128 may determine whether or not the growth of the product data has converged on the basis of a growth potential index value. For example, the analysis processing unit 128 can determine whether or not a change amount between generations has monotonically decreased in accordance with the accumulation of growth potential index values of the generations and the growth of the product data has converged according to whether the change amount is smaller than a predetermined change amount threshold value. When it is determined that the growth has converged, the analysis processing unit 128 may stop the processing of steps S06 to S20.

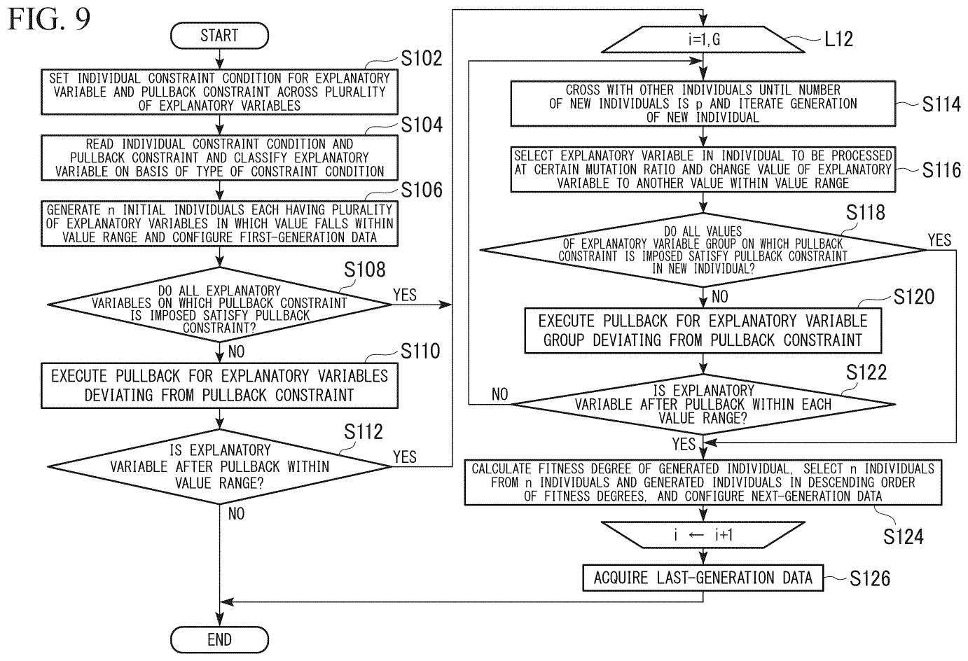

Next, another example of information processing according to the present embodiment will be described. FIG. 9 is a flowchart showing another example of information processing according to the present embodiment. In the example shown in FIG. 9, the generation of an individual and the processing of explanatory variables will be mainly described.

### (Step S102)

The constraint condition setting unit 124 sets an individual constraint condition for each explanatory variable as a constraint condition and sets a pullback constraint for a set of a plurality of explanatory variables. Specifically, the constraint condition setting unit 124 sets a constraint condition imposed on each of the sum i of the thicknesses of the first variable member group, the sum j of the thicknesses of the second variable member group, and the electrode length α as an individual constraint condition and sets a constraint condition imposed on the diameter D of the wound body WB or sets the diameter D of the wound body WB to be less than or equal to the diameter A of the cylindrical can KA as a pullback constraint. The constraint condition setting unit 124 stores constraint condition information indicating the set constraint condition in the storage unit 140.

### (Step S104)

The generation unit 126a reads constraint condition information indicating an individual constraint condition and a pullback constraint from the storage unit 140. The generation unit 126a identifies an explanatory variable to which the individual constraint condition and the pullback constraint are applied and classifies an individual explanatory variable on the basis of a type of constraint condition.

### (Step S106)

The generation unit 126a generates n initial individuals by iterating a process of setting a value of the explanatory variable so that it falls within a value range indicated by an individual constraint condition for each explanatory variable. The generation unit 126a configures first-generation data including the n initial individuals that have been generated and stores the first-generation data in the storage unit 140.

### (Step S108)

The constraint condition verification unit 126c executes a pullback constraint determination step for each of the n initial individuals and determines whether or not a plurality of explanatory variables to which the pullback constraint is applied satisfy the pullback constraint. When all explanatory variables satisfy the pullback constraint (step S108; YES), the process proceeds to a loop L12. When there is an individual having an explanatory variable deviating from the pullback constraint (step S108; NO), the process proceeds to step S110.

### (Step S110)

The constraint condition verification unit 126c executes a pullback step for a set of explanatory variables that deviate from the pullback constraint and resets a value of a corresponding explanatory variable.

### (Step S112)

The constraint condition verification unit 126c executes an individual constraint determination step for the reset value reset in a pullback process and determines whether or not it is within a value range constituting the individual constraint condition set for the corresponding explanatory variable. When it is determined that all values are within the set value range (step S112; YES), the process proceeds to the loop L12. When there is a constraint deviation individual that is an individual having a reset value deviating from the set value range (step S112; NO), the process of FIG. 9 is stopped.

A process of the loop L12 includes the processing of steps S114 to S124, and these processing steps are iterated G times. An initial value of the number of iterations i is set to 1 and the individual processing unit 126 counts the number of iterations i by adding 1 to the number of iterations i (incrementing the number of iterations i by 1) after the end of the processing of step S126. When the number of iterations i exceeds G, the loop L12 is released and the process proceeds to step S126.

### (Step S114)

By executing a crossover step, the individual manipulation unit 126b iterates a process of randomly selecting an individual of interest to be processed from n parent individuals, crossing with other reference individuals, and generating a new individual as a child individual until the number of new individuals reaches p.

### (Step S116)

The individual manipulation unit 126b generates a new individual as a child individual by randomly selecting an explanatory variable of interest in the individual of interest to be processed at a certain mutation ratio and changing a value of the explanatory variable of interest to a target value within a value range that forms the individual constraint condition.

### (Step S118)

The constraint condition verification unit 126c executes a pullback constraint determination step for each of the newly generated child individuals and determines whether or not a plurality of explanatory variables on which the pullback constraint is imposed satisfy the pullback constraint. When it is determined that all explanatory variables are within the set value range (step S118; YES), the process proceeds to step S126. When there is an individual having a reset value deviating from the set value range (step S118; NO), the process proceeds to step S120.

### (Step S120)

The constraint condition verification unit 126c executes a pullback step for a set of explanatory variables that deviate from the pullback constraint and resets the value of the corresponding explanatory variable. Specifically, the constraint condition verification unit 126c resets the sum i of the thicknesses of the first variable member group, the sum j of the thicknesses of the second variable member group, and the electrode length α on the basis of Pullback Expressions (2).

### (Step S122)

The constraint condition verification unit 126c executes an individual constraint determination step for the reset value reset in a pullback process and determines whether or not it is within the value range that forms the individual constraint condition set for the corresponding explanatory variable. When it is determined that all explanatory variables are within the set value range (step S122; YES), the process proceeds to step S124. When there is a constraint deviation individual that is an individual having a reset value deviating from the set value range (step S122; NO), the process proceeds to step S114.

### (Step S124)

The sorting unit 126d refers to the current-generation data and calculates a fitness degree using a predetermined mathematical model from an explanatory variable group for each child individual that is a newly generated individual. The sorting unit 126d selects n individuals in descending order of fitness degrees from a set of n parent individuals and new child individuals and stores next-generation data including the n selected individuals in the storage unit 140.

### (Step S126)

The analysis processing unit 128 reads last-generation data stored in the storage unit 140 and selects one or more predetermined individuals from the read last-generation data in descending order of fitness degrees. The analysis processing unit 128 can determine a production condition indicated in the explanatory variable group of the selected individual as an optimal design condition. Thereafter, the process of FIG. 9 ends.

Although an example in which the information processing device 10 is connected to the manipulation input unit 158 and the display unit 160 by wire or wirelessly, manipulation information is input from the manipulation input unit 158, and display data is output to the display unit 160 has been described above, the present invention is not limited thereto. An input source of the manipulation information and an output destination of the display data may be external equipment connected using a network. In this case, in the information processing device 10, one or both of the manipulation input unit 158 and the display unit 160 may be omitted.

As described above, according to the present embodiment, the information processing device 10 includes the individual processing unit 126 configured to execute a crossover step of generating a new individual by changing a value of an explanatory variable of a part of an individual selected with a first probability (for example, a crossover ratio) from current-generation data, which has n individuals each being an explanatory variable group having a plurality of explanatory variables, to a target value based on a value of a corresponding explanatory variable of another individual, a mutation step of generating a new individual by changing a value of an explanatory variable of a part of an individual selected with a second probability (for example, a mutation ratio) from the current-generation data to another value, and a sorting step of sorting n individuals of next-generation data from original n individuals and generated individuals on the basis of a fitness degree calculated from an explanatory variable group for each individual.

The individual processing unit 126 execute a pullback constraint determination step of setting information indicating a sum value of thicknesses of a first member group included in an electrode of a cylindrical battery, information indicating a sum value of thicknesses of a second member group, and information indicating an electrode length as the explanatory variable group, generating a diameter of a wound body as an individual from the information indicating the sum value of the thicknesses of the first member group, the information indicating the sum value of the thicknesses of the second member group, and the information indicating the electrode length that have been set, and determining presence or absence of an explanatory condition deviating from the pullback constraint, which is a constraint condition across a plurality of explanatory variables for each individual that has been generated; and a pullback step of resetting a reset value satisfying the pullback constraint with respect to the plurality of explanatory variables deviating from the pullback constraint.

The present embodiment may be implemented as a computer-readable non-transitory storage medium storing a computer program for causing a computer of an information processing device to execute the information processing method having a crossover step, a mutation step, a sorting step, the pullback constraint determination step, and the pullback step.

According to this configuration, when a constraint deviation individual in which the reset value set in the pullback process deviates from the individual constraint conditions for the diameter of the wound body as a newly generated individual in the crossover step and the mutation step has occurred, a value based on a plurality of explanatory variables is applied to the constraint deviation individual. Therefore, it is possible to prevent a case where resetting a value based on a plurality of explanatory variables, the pullback constraint determination step, and the pullback step are iterated for the explanatory variable group constituting the constraint deviation individual and a process is prolonged without determining the explanatory variable group. Because the child individual becomes a candidate for the next-generation data and the explanatory variable group constituting the parent individual that satisfies the constraint condition is handed over to the next generation, the data is stabilized without degrading the accuracy of the solution. For this reason, it is possible to design electrodes that can be encapsulated in cylindrical containers while maintaining the balance of the evolutionary results of multi-objective optimization.

The pullback constraint may indicate that the diameter of the wound body is less than or equal to a diameter of a cylindrical container, and the pullback step may determine the reset value so that the diameter of the wound body is less than or equal to the diameter of the cylindrical container on the basis of the plurality of explanatory variables with respect to the plurality of explanatory variables deviating from the pullback constraint.

According to this configuration, the values of the individual explanatory variables are set so that the diameter of the wound body is less than or equal to the diameter of the cylindrical container between two or more explanatory variables on which the pullback constraint is imposed. Therefore, it is possible to diversify individuals that satisfy the pullback constraint.

The setting step may include setting information indicating a cylindrical diameter, information indicating a winding core diameter, and information indicating a sum value of thicknesses of a third member group included in the electrode of the cylindrical battery, and the generation step may include generating the diameter of the wound body from the sum value of the thicknesses of the first member group, the sum value of the thicknesses of the second member group, the electrode length, the cylindrical diameter, the winding core diameter, and the sum value of the thicknesses of the third member group included in the electrode of the cylindrical battery. The first member group includes a positive electrode collector foil and a negative electrode collector foil, the second member group includes a positive electrode active material and a negative electrode active material, and the third member group includes a separator.

According to this configuration, the information indicating the cylindrical diameter, the information indicating the winding core diameter, and the information indicating the sum value of the thicknesses of the third member group included in the electrode of the cylindrical battery are set. Therefore, the diameter of the wound body can be generated on the basis of the information indicating the cylindrical diameter, the information indicating the winding core diameter, and the information indicating the sum value of the thicknesses of the third member group included in the electrode of the cylindrical battery.

Although embodiments of the present invention have been described in detail with reference to the drawings, specific configurations are not limited to the above-described embodiments and various design changes and the like can be made without departing from the scope and spirit of the present invention.

What is claimed is:

1. An information processing method in which an information processing device executes
a crossover step of generating a new individual by changing a value of an explanatory variable of a part of an individual selected with a first probability from current-generation data, which has n (n is an integer of 3 or more) individuals each being an explanatory variable group having a plurality of explanatory variables, to a target value based on a value of a corresponding explanatory variable of another individual,
a mutation step of generating a new individual by changing a value of an explanatory variable of a part of an individual selected with a second probability from the current-generation data to another value, and
a sorting step of sorting n individuals of next-generation data from stored individuals and generated individuals on the basis of a fitness degree calculated from an explanatory variable group for each individual,
wherein the information processing device executes:
a setting step of setting information indicating a sum value of thicknesses of a first member group included in an electrode of a cylindrical battery, information indicating a sum value of thicknesses of a second member group, and information indicating an electrode length as the explanatory variable group;
a generation step of generating a diameter of a wound body as an individual from the information indicating the sum value of the thicknesses of the first member group, the information indicating the sum value of the thicknesses of the second member group, and information indicating the electrode length set in the setting step;
a pullback constraint determination step of determining presence or absence of an explanatory condition deviating from the pullback constraint, which is a constraint condition across a plurality of explanatory variables for each individual generated in the generation step; and
a pullback step of resetting a reset value based on a plurality of explanatory variables with respect to the plurality of explanatory variables deviating from the pullback constraint.

2. The information processing method according to claim 1,
wherein the pullback constraint indicates that the diameter of the wound body is less than or equal to a diameter of a cylindrical container, and
wherein the pullback step includes determining the reset value so that the diameter of the wound body is less than or equal to the diameter of the cylindrical container on the basis of the plurality of explanatory variables with respect to the plurality of explanatory variables deviating from the pullback constraint.

3. The information processing method according to claim 1,
wherein the setting step includes setting information indicating a cylindrical diameter, information indicating a winding core diameter, and information indicating a sum value of thicknesses of a third member group included in the electrode of the cylindrical battery, and
wherein the generation step includes generating the diameter of the wound body from the sum value of the thicknesses of the first member group, the sum value of the thicknesses of the second member group, the electrode length, the cylindrical diameter, the winding core diameter, and the sum value of the thicknesses of the third member group included in the electrode of the cylindrical battery.

4. The information processing method according to claim 3,
wherein the first member group includes a positive electrode collector foil and a negative electrode collector foil,
wherein the second member group includes a positive electrode active material and a negative electrode active material, and
wherein the third member group includes a separator.

5. A computer-readable non-transitory storage medium storing a computer program for causing a computer of an information processing device to execute the information processing method according to claim 1.

6. An information processing device comprising
a storage unit configured to store current-generation data, which has n (n is an integer of 3 or more) individuals each being an explanatory variable group having a plurality of explanatory variables; and
an individual processing unit configured to
generate a new individual by changing a value of an explanatory variable of a part of an individual selected with a first probability from the current-generation data to a target value based on a value of a corresponding explanatory variable of another individual,
generate a new individual by changing a value of an explanatory variable of a part of an individual selected with a second probability from the current-generation data to another value, and
sort n individuals of next-generation data from stored individuals and generated individuals on the basis of a fitness degree calculated from an explanatory variable group for each individual,
wherein the individual processing unit
sets information indicating a sum value of thicknesses of a first member group included in an electrode of a cylindrical battery, information indicating a sum value of thicknesses of a second member group, and information indicating an electrode length as the explanatory variable group,
generates a diameter of a wound body as an individual from the information indicating the sum value of the thicknesses of the first member group, the information indicating the sum value of the thicknesses of the second member group, and the information indicating the electrode length that have been set,
determines presence or absence of an explanatory condition deviating from the pullback constraint, which is a constraint condition across a plurality of explanatory variables for each individual that has been generated, and
resets a reset value based on a plurality of explanatory variables with respect to the plurality of explanatory variables deviating from the pullback constraint.
